(19) United States
(12) Patent Application Publication
(10) Pub. No.: US 2020/0265509 A1
(43) Pub. Date: Aug. 20, 2020

(54) SECURE AND TRUSTED MULTI-TENANT SERVICE DELIVERY PLATFORM FOR DISTRIBUTED MULTITENANT-CAPABLE AI SOLUTION MODEL COMPUTE PROCESSORS

(71) Applicant: Pathtronic Inc., San Francisco, CA (US)

(72) Inventors: Sateesh Kumar Addepalli, San Jose, CA (US); Vinayaka Jyothi, Sunnyvale, CA (US); Ashik Hoovayya Poojari, Sunnyvale, CA (US)

(21) Appl. No.: 16/789,371

(22) Filed: Feb. 12, 2020

Related U.S. Application Data
(60) Provisional application No. 62/807,677, filed on Feb. 19, 2019.

(51) Int. Cl. G06Q 30/06; G06N 20/00; G06N 5/04; G06Q 20/12; G06Q 30/08; G06Q 30/02; G06Q 20/08; G06Q 10/06; G06F 21/62; G06F 11/30; G06F 11/34; H04L 12/911; H04L 29/08

(52) U.S. Cl. CPC G06Q 30/0645; G06N 20/00; G06N 5/04; G06Q 20/127; G06Q 30/08; G06Q 30/0282; G06Q 2220/18; G06Q 10/06315; G06F 21/6245; G06F 11/3024; G06F 11/3495; H04L 47/827; H04L 67/1095; G06Q 20/0855

(57) ABSTRACT

Aspects of the present disclosure are presented for an AI solution model processing infrastructure that allows owners of machines that perform AI model training and inference to rent the processing resources of the AI machines as a service to the one or more subscribers on an as-needed basis. This allows a subscriber to dynamically rent the service to run one or more AI models to train or infer in a given place/location to accomplish particular AI goals without owning an AI solution model processing-capable machine at a given location. Rather than going through the hard work, resource utilization and cost of doing setting one's own AI compute processing, the rental service described herein will provide a pay as you need scheme to run one's AI model in a rented environment.

### CROSS REFERENCE TO RELATED APPLICATIONS

This application claims priority to U.S. Provisional Application No. 62/807,677, filed Feb. 19, 2019, and titled “SECURE AND TRUSTED MULTI-TENANT SERVICE DELIVERY PLATFORM FOR DISTRIBUTED MULTITENANT-CAPABLE AI SOLUTION MODEL COMPUTE PROCESSORS,” the disclosure of which is hereby incorporated herein by reference in its entirety and for all purposes.

### TECHNICAL FIELD

The subject matter disclosed herein generally relates to artificial intelligence. More specifically, the present disclosures relate to systems and methods for a real time, customizable AI model collaboration, trading, and/or licensing and subscription service, facilitating a marketplace over a trusted AI model network.

### BACKGROUND

Currently, AI models have been trained and then deployed in a wide range of edge applications, such as in autonomous and smart connected vehicles, transportation, health and wellness, industrial Internet of Things (IoT), smart cities/spaces, and many more public and private environments. This trend of AI deployment is going to grow exponentially. It is desirable to develop infrastructure to securely facilitate these areas of growth.

### BRIEF DESCRIPTION OF THE DRAWINGS

Some embodiments are illustrated by way of example and not limitation in the figures of the accompanying drawings.

FIG. 1 shows a high level diagram of the aggregate system showing example interactions to the multiple components described herein, according to some embodiments.

FIG. 2 shows an example functional diagram of the AI-Multi Tenancy Service Broker (AI-MTSB), according to some embodiments.

FIG. 3 shows an example block diagram of the AI multi-tenancy service marketplace (AI-MTSMP), according to some embodiments.

FIG. 4 shows an example block diagram of the AI multitenancy service subscriber manager (AI-MTSSM), according to some embodiments.

FIG. 5 provides a block diagram example of the AI multi-tenancy transaction fulfillment system (AI-MTSTFS), according to some embodiments.

FIG. 6 shows an overall AI trusted multi-tenant service network (AI-TMTSN) architecture, according to some embodiments.

FIG. 7 shows an example diagram of the AI user device server (AI-UDS) and its interactions to components of the service platform, according to some embodiments.

FIG. 8 shows a representation of multiple AI solution model compute processors, according to some embodiments.

FIG. 9 shows a system diagram of implementing the concept of a dynamic pay-as-you-use AI solution model processor service, according to some embodiments.

FIG. 10 shows an example of an AI solution model compute processor performing a multi-tenancy execution in a dedicated virtual multilane configuration, according to some embodiments.

FIG. 11 shows an example of an AI solution model compute processor performing a multi-tenancy execution in a time multiplexed virtual multilane configuration, according to some embodiments.

### DETAILED DESCRIPTION

Applicant of the present application owns the following U.S. Provisional Patent Applications, each filed on Feb. 4, 2019, the disclosures of each of which are herein incorporated by reference in their entireties:
U.S. Provisional Patent Application 62/801,044, titled SYSTEMS AND METHODS OF SECURITY FOR TRUSTED AI HARDWARE PROCESSING;
U.S. Provisional Patent Application 62/801,046, titled SYSTEMS AND METHODS FOR ARTIFICIAL INTELLIGENCE HARDWARE PROCESSING;
U.S. Provisional Patent Application 62/801,048, titled SYSTEMS AND METHODS FOR ARTIFICIAL INTELLIGENCE WITH FLEXIBLE HARDWARE PROCESSING FRAMEWORK;
U.S. Provisional Patent Application 62/801,049, titled SYSTEMS AND METHODS FOR CONTINUOUS AND REAL-TIME AI ADAPTIVE SENSE LEARNING;
U.S. Provisional Patent Application 62/801,050, titled LIGHTWEIGHT, HIGH SPEED AND ENERGY EFFICIENT ASYNCHRONOUS AND FILE SYSTEM-BASED ARTIFICIAL INTELLIGENCE PROCESSING INTERFACE FRAMEWORK; and
U.S. Provisional Patent Application 62/801,051, titled SYSTEMS AND METHODS FOR POWER MANAGEMENT OF HARDWARE UTILIZING VIRTUAL MULTILANE ARCHITECTURE.

Applicant of the present application also owns U.S. Provisional Patent Application 62/806,544, titled REAL-TIME CUSTOMIZABLE AI MODEL COLLABORATION AND MARKETPLACE SERVICE OVER A TRUSTED AI MODEL NETWORK, filed on Feb. 15, 2019, the disclosure of which is herein incorporated by reference in its entirety.

Applicant of the present application owns the following U.S. Non-provisional Patent Applications, each filed on Jul. 31, 2019, the disclosures of each of which are herein incorporated by reference in their entireties:
U.S. Non-Provisional patent application Ser. No. 16/528,545, titled SYSTEMS AND METHODS OF SECURITY FOR TRUSTED AI HARDWARE PROCESSING;
U.S. Non-Provisional patent application Ser. No. 16/528,543, titled SYSTEMS AND METHODS FOR ARTIFICIAL INTELLIGENCE HARDWARE PROCESSING;
U.S. Non-Provisional patent application Ser. No. 16/528,548, titled SYSTEMS AND METHODS FOR ARTIFICIAL INTELLIGENCE WITH FLEXIBLE HARDWARE PROCESSING FRAMEWORK;
U.S. Non-Provisional patent application Ser. No. 16/528,549, titled SYSTEMS AND METHODS FOR CONTINUOUS AND REAL-TIME AI ADAPTIVE SENSE LEARNING;
U.S. Non-Provisional patent application Ser. No. 16/528,551, titled LIGHTWEIGHT, HIGH SPEED AND ENERGY EFFICIENT ASYNCHRONOUS AND FILE SYSTEM-BASED ARTIFICIAL INTELLIGENCE PROCESSING INTERFACE FRAMEWORK; and
U.S. Non-Provisional patent application Ser. No. 16/528,553, titled SYSTEMS AND METHODS FOR POWER MANAGEMENT OF HARDWARE UTILIZING VIRTUAL MULTILANE ARCHITECTURE.

Today, in general, AI models have been trained and then deployed in a wide range of edge applications namely, autonomous and smart connected vehicles, transportation, health and wellness, industrial Internet of Things (IoT), smart cities/spaces, and many more public and private environments. This trend of AI deployment is going to grow exponentially.

However, AI model creation is a tedious process that requires extensive learning and training, with a continuous stream of specific set of sense data that can be applied to customized/personalized AI applications/solutions that satisfy a given use case need.

Future applications of AI are going to be prevalent and important. Reaching this stage may demand the creation of millions or even billions of AI models to be trained in real-time for these and other similar use cases. The approach of learning and training these many AI models by perhaps billions of users/entities for billions of simultaneous and similar use cases will not be practical with current infrastructure, due to the sheer volume of sense data, communication bottlenecks, processing power, energy and cost.

Aspects of the present disclosure are presented for an AI solution model processing infrastructure that may be embedded in a plethora of distributed devices/machines (e.g., vehicles, Internet of things (IoT) devices, robots, routers, appliances, servers, health/biological machines, etc.), where the owner can rent his/her AI solution model processing resources as a service to the one or more subscribers on an as-needed basis. This allows the subscriber to dynamically rent the service to run one or more AI models to train or infer in a given place/location to accomplish his/her AI goals without owning an AI solution model processing-capable machine at a given location. Rather than going through the hard work, resource utilization and cost of doing setting one's own AI compute processing, the rental service described herein will provide a pay as you need scheme to run one's AI model in a rented environment.

As some example use cases, suppose a user wants to train an existing AI model for an autonomous vehicle/robot around a particular geographical area. The user may therefore want to look for a vehicle or robot that is already operating in that geographical area that also has the same or similar sensing/actuating and AI compute processing capabilities. If such a vehicle or robot, or corresponding set of AI knowledge, is available via a marketplace that satisfies the user's needs, then the user may opt to rent or subscribe a full or partial AI solution model, and/or a processor used to operate the AI solution model, along with sensing/actuating capabilities, for a given period of time. Renting the existing solution may be preferable to developing an AI solution model from scratch.

As another example, suppose a user is travelling to a new place for a vacation or business trip, and wants to download one or more AI models into a rental vehicle equipped with safe autonomous driving and/or for AI driven in-vehicle adaptive comfort, etc. The user may want to download suitable AI models to the vehicle on a rental basis.

As yet another example, suppose a car manufacturing company purchases and installs a multi-tenancy AI system platform for running AI models in its cars. A user may purchase a car and may want to use the service to customize the vehicle, such as providing temperature control or autonomous driving services. The car manufacturing company may also wish to provide its AI system platform to another car manufacturing company for use in its cars. In such cases, the car company can rent out the computational platform to a second car company, instead of the second car company having to purchase and install new chips or other technology in the cars. The first car company can build revenue, and the second car company can deliver instant services while the car-owners need not buy new hardware systems to avail themselves of the services.

As yet another example, suppose a biological/health care lab or research facility utilizes an AI system configured to run AI solution models that make inferences using an array of sensors/actuators. Suppose a user, such as a doctor or patient in collaboration with the health care institute, wants to extensively sense, learn, train &/or infer an AI model to perform research on a disease, health symptom or biological activity. If such an AI model is already available in a marketplace that holds AI models, then the user can may opt to rent or subscribe a full or partial use of the AI solution model, along with sensing/actuating capabilities for a given period of time, instead of owning an entire machine that may not make sense in terms of cost of ownership, maintenance and convenience, etc.

In general, it is believed there will be a large number of use cases where personalized or customized AI models can be downloaded for training and/or inference into devices owned by another entity. In these cases, the entities may decide it is more effective to rent or subscribe to a service that offers the AI solution models and/or their processing engines with required capabilities, rather than acquire the infrastructure to develop similar AI models on their own. The rented AI solution models may also allow for adjustments or modifications, using additional training, to customize or personalize a version of the rented AI solution model for particular use by the renting entity.

Currently, there is neither a trusted nor secure AI solution model compute processor infrastructure, nor trusted & secure real-time marketplace with delivery service capabilities for providing AI solution models on a rental or subscription basis.

Aspects of the present disclosure are presented for systems and methods of a trusted and secure AI solution model compute processor infrastructure, and a secure, real-time marketplace with delivery service capabilities for providing AI solution models on a rental or subscription basis. In some embodiments, the AI solution model compute processor infrastructure provides multitenancy capabilities, meaning that multiple users may utilize the AI solution models, either in training or inferring, in parallel. In some embodiments, users may able to promote and rent their devices that can generate and run AI solution models. These devices may be multi-tenancy capable, with sensing/actuating capabilities that are used to develop the data that the AI solution models infer on. In some embodiments, subscribers who want to subscribe or rent these AI solution models and/or their processor infrastructures may be able to access a marketplace for where the sellers or vendors have offered up their services. In some embodiments, all of the transactions between parties may be in a trusted and secure setting, and in some embodiments, special devices or applications on devices are presented that include trusted and secure capabilities for transmitting and receiving these AI solution models, which may also be trained or modified by the tenant in some cases.

Aspects of the present disclosure may include two distinct components: 1) the secure & trusted AI multi-tenant service platform (“service delivery platform”), which provides the marketplace and subscriber/rental infrastructure for distributing AI solution models and the AI system infrastructure to multiple tenants; and 2) large scale distributed multi-tenant capable AI solution model compute processors (“AI solution model compute processors”), which are the AI system infrastructures that may be rented out to tenants and may be configured to run AI solution models. The distribution of the utilization of the AI solution model compute processors to tenants may be calculated and coordinated by the AI multi-tenant service platform, which needs to account for resource management and resource capabilities to each tenant, based on their rental needs.

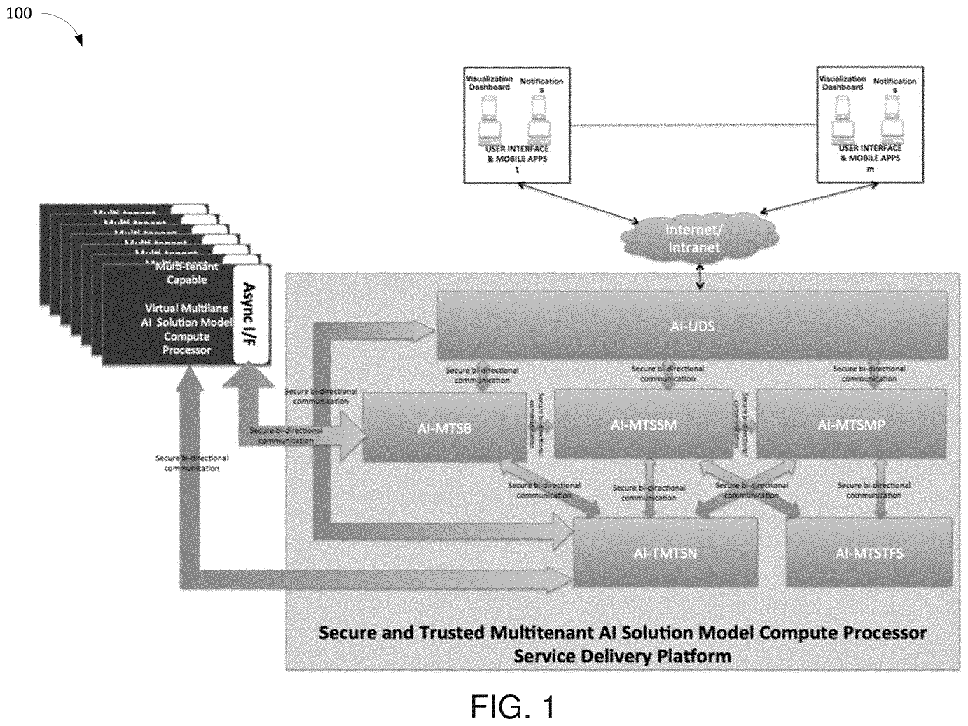

FIG. 1 shows a high level diagram 100 of the aggregate system showing example interactions to the multiple components described herein, according to some embodiments. As shown, there may be multiple multi-tenant capable AI solution model compute processors, and they are communicatively coupled to the service delivery platform that includes a number of different modules that will be described more, below. The users may interface with the totality of this system setup via a network, such as the Internet or a local intranet, using their respective mobile devices.

The Secure and Trusted AI Multi-Tenant AI Solution Model Compute Processor Service Delivery Platform

Referring again to FIG. 1, the service delivery platform includes a number of different modules, according to some embodiments. These modules may be implemented using hardware, software, or a combination of both. For example, some modules may be implemented using FPGAs, one or more processors, one or more circuits, and the like. These modules may be implemented in a cloud server that includes a collection of servers, and may provide interface to multiple users, according to some embodiments. These modules include the following:
1. AI-MTSB: AI-Multi Tenancy Service Broker;
2. AI-MTSMP: AI-Multi Tenancy Service Market Place;
3. AI-MTSSM: AI-Multi Tenancy Service Subscriber Manager;
4. AI-MTSTFS: AI-Multi Tenancy Transaction Fulfillment System;
5. AI-TMTSN: AI-Trusted Multi Tenant Service Network;
6. AI-UDS: AI-User Device Server; and
7. AI Multi Tenancy Service User Interface and Mobile/System/Web Apps.

1. AI-MTSB: AI-Multi Tenancy Service Broker

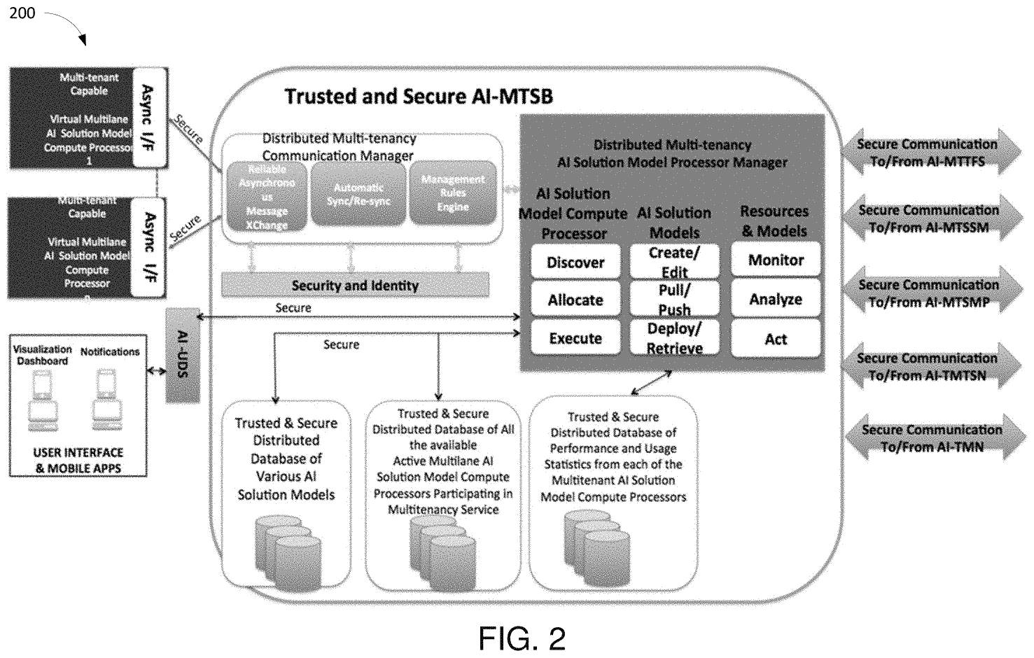

FIG. 2 shows an example functional diagram 200 of the AI-MTSB, according to some embodiments. The AI-MTSB's main role is to allocate appropriate AI solution model processor resources, to facilitate execution on behalf of tenants and their AI solution models. In addition, it may constantly monitor the AI solution model processor resources running models usage and performance for reporting, accounting and billing purposes. To rent processor resources to run AI solution models for tenants, it is more efficient when the allocations can be tailored to the tenants' needs, including how much processing is required, for how long, and during what time. This requires an entity that can compute how many resources are needed for training or inference of an AI solution model—noting that this amount can vary for any unit time throughout the course of the process—as well know what resources are already being used and when. The AI-MTSB performs these types of special calculations to optimize the rental capabilities of the multi-tenancy systems.

The AI-MTSB interacts with the MTSSM, AI-MTSMP, AI-TMTSN, and AI-TMN at appropriate times to accomplish these required functions.

Of note, the AI-MTSB as shown includes a distributed multi-tenancy communication manager, and a distributed multi-tenancy AI solution model processor manager.

In some embodiments, the role of the distributed multi-tenancy communication manager is to securely and reliably communicate with respective asynchronous interfaces of all the active AI solution model compute processors that may be distributed across a processor bus (e.g., PCIe), intranet or internet in various non-cluster and cluster formations.

In some embodiments, the distributed multi-tenancy AI solution model processor manager has several roles: a) manage multi-tenant capable virtual multilane AI solution model processor resources; b) manage AI solution models; and c) monitor and/or analyze AI model solution processors and AI solution model usage and performance.

a. Manage Multi-Tenant Capable Virtual Multilane AI Solution Model Processors Resources

The AI solution model processor manager may be configured to perform a discover function of new AI solution model processors. It may dynamically discover actively available multi-tenant capable virtual multilane AI solution model processors and their respective capabilities, such as identify the number of AI processing virtual multilanes, processing speeds, feeds, sensors, I/Os, etc.

The processors can be discovered after they are pushed by the marketplace or through dynamic advertisement by the virtual multilane AI solution model processors. In other cases, they can also be discovered by pulling the capabilities from the AI solution model processor when a query is specifically issued.

Once the AI model solution processor is discovered, along with its capabilities, it is securely registered into the AI-TMTSN and designated a secure key. The distributed, trusted AI compute resource database with a unique provider token/key may not be tampered with, according to some embodiments.

In addition, the AI solution model processor manager may be configured to perform an allocate function. Based on an explicit or implicit request from the tenant, and its AI solution model needs resource from the assigned multi-tenant capable virtual multilane AI solution model processor, required virtual lanes, speed and feed resources are allocated on a shared/dedicated manner and assigned to the requested tenant and one or more AI solution model(s) to be executed on it. Appropriate unique time bound subscription tokens/keys with appropriate coding types may be used as created and associated by the AI-MTSSM in coordination with the AI-TMTSN.

Furthermore, the AI solution model processor manager may be configured to perform an execute function. Once one or AI solution model processors is allocated to a given tenant, based on the calendar schedule of execution, an execution request is sent to the corresponding AI computer processors along with the above unique time bound subscription token/key.

For each of the above functions, there may be a counterpart in the AI solution model processor side to receive and respond to the requests.

b. Manage AI Solution Models:

This section of the platform provides the following tools to a tenant to use while handling the rented AI solution model:

i. Create/Edit: Provides the ability to create and edit the AI solution model along with the user interface exposed via a visualization tool and apps.

ii. Push/Pull: Provides the ability to push or pull AI solution models to/from the AI-TMN. Further details are provided in U.S. Provisional Application 62/806,544, which is again incorporated herein by reference.

iii. Deploy/Retrieve:

Deploy: Provides the ability to deploy the AI solution model to the AI solution model processor that the tenant has subscribed to/rented for learning, training, inferencing and decision purposes. This is achieved by interacting with the asynchronous interface of the associated AI solution model processor via the distributed multi-tenancy communication manager.

Retrieve: Provides the ability to retrieve the AI solution model from the AI solution model processor that it is subscribed to/rented that is being trained. New data that may be incorporated into the AI solution model may also be retrieved, thereby allowing for the AI solution model to be updated and improved upon retrieval.

c. Resource and Model Monitoring and Reporting of Usage and Performance:

This section of the platform provides tools to the monitor, analyze and act modules that apply to all the active AI solution processors and their corresponding AI models for performance, usage and error statistics associated with a tenant. This information may be used by the AI-MTSTFS, AI-MTSSM for accounting, billing and transaction fulfillment purposes.

2. AI-MTSMP: AI Multi-Tenancy Service Marketplace

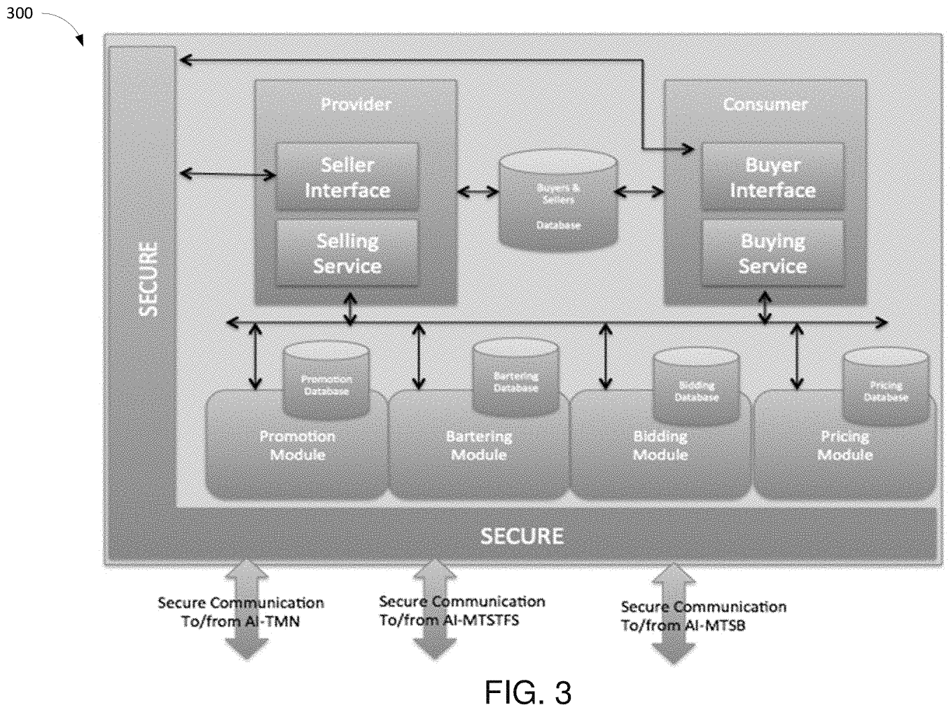

Referring to FIG. 3, the block diagram 300 shows an example of the AI multi-tenancy service marketplace, according to some embodiments. The AI-MTSMP enables real-time bidding of a subscription, selling and buying of a given multitenancy AI solution model processor service that satisfies certain bidding criteria. These may include but are not limited to, types of processing speeds, feeds, sensing, AI solution model needs, location, duration, time shared or dedicated processing, and price range.

As shown in FIG. 3, in some embodiments, the AI-MTSMP includes the following: a selling service module; a buying service module; and a selling service interface. The selling service interface exports various user interface gadgets corresponding to each module that is used by the selling service.

The AI-MTSMP may also include a buying service interface. The buying service interface exports various user interface gadgets corresponding to each module that is used by the buying service. The AI-MTSMP also may include a bidding module, a pricing module, a promotion module, and a bartering module.

The module for purchasing and offering of rental services subscriptions of processor compute time may interact with the rest of the modules to accomplish these functions.

In addition, the selling and buying service units of the AI-MTSMP interact with the AI-TMN, AI-MTSTFS, and AI-MTSB modules to accomplish respective specific platform service needs to complete the tenant's subscription of a given Multi-tenancy AI solution model processor service.

3. AI-MTSSM: AI Multi-Tenancy Service Subscriber Manager

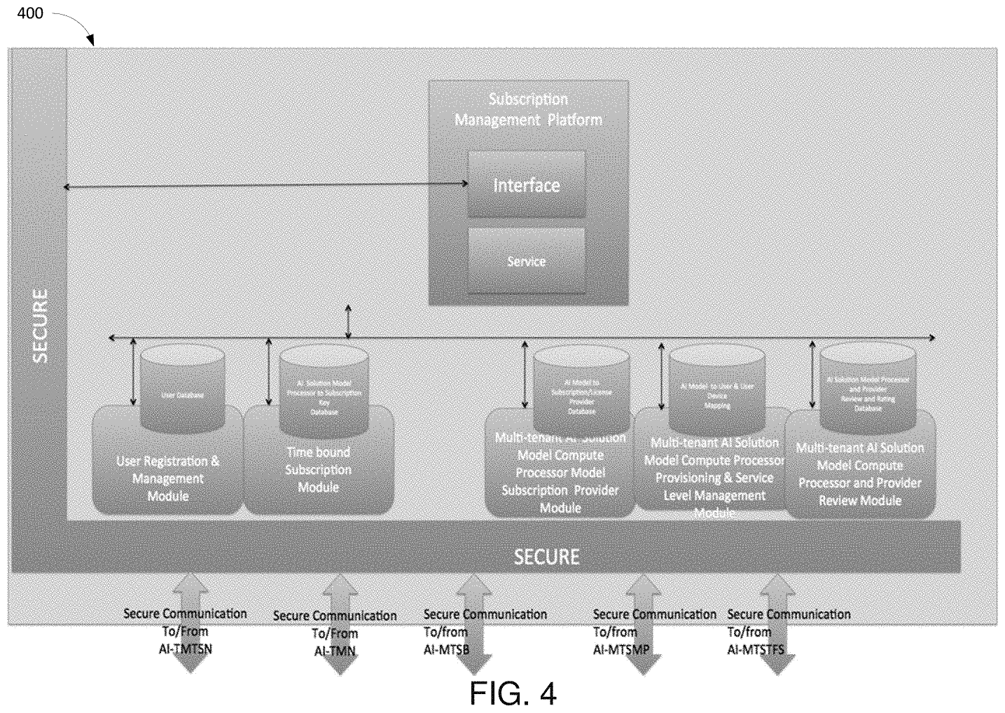

FIG. 4 shows an example block diagram 400 of the AI multitenancy service subscriber manager, according to some embodiments. The AI-MTSSM interacts with the other modules and performs the following services:

A. User/Entity Registration and Management—The AI-MTSSM provides the ability to register and manage multi-tenant capable AI solution model processor service providers and service subscribers/tenants.

B. Subscription Management—The AI-MTSSM provides for a pay as you use subscription of the service for using the AI solution model processors, and may provide various subscription granularities, such as with a time bound subscription token/key dependent on tenant user requirements, tenant usage or other payment/promotion options.

The subscription key can be uniquely tied to a user and/or the user's device, or a group of users and their respective devices.

In some embodiments, the AI-MTSSM may coordinate with the AI-TMTSN to provide a code associated time bound subscription key for a given AI solution model compute processor. The subscription key may be coded with various access rights:
I. Compute Processor Schedule Type:

i. Shared

ii. Dedicated
II. Compute Processor Function Type:

i. Inference & Decision

ii. Training

iii. Both
III. AI Solution Model Need Type:

i. Bring your own model

ii. Subscribe to a specific model of the platform

Compute code rights may be created by combining a selected type from each of the categories I, II, & III.

c. Mapping to the User—The AI-MTSSM also provides mapping of the AI solution model compute processor to the rental user.

d. Service Level Management—The AI-MTSSM also provides service level management and provisioning services for each AI solution model compute processor. Using the mapping functions from the AI-MTSB, this provides mapping of the AI solution model compute processor to a corresponding tenant subscriber, and the AI-MTSSM maintains various service level agreements (SLAs) associated with the tenant subscriber.

e. Exporting to Interfaces—The AI-MTSSM interface allows for exporting various user interface gadgets corresponding to each module to the associated device of the user.

f. Ratings—The AI-MTSSM also allows for reviewing and rating the AI solution model compute processor and provider. The rating system may allow for comparisons to be made between processors or providers. This improves trust of the platform by removing bad/malicious AI solution model compute processors and the associated provider. If this software app is used at the user end, it can allow for a direct feedback from the user. Using re-informant learning, the present system can be configured to ask the user who brought the model and if everything is going well.

4. AI-MTSTFS: AI Multi-Tenancy Transaction Fulfillment System

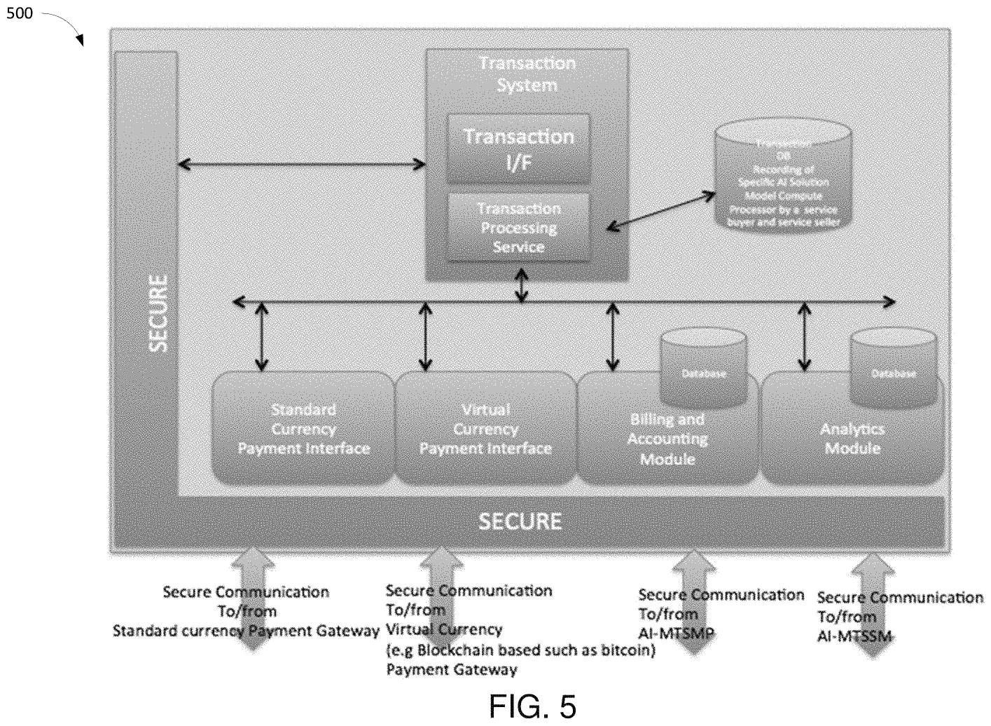

FIG. 5 provides a block diagram example 500 of the AI multi-tenancy transaction fulfillment system (AI-MTSTFS), according to some embodiments. FIG. 5 shows the AI multi-tenancy transaction fulfillment system with a peer-to-peer payment system. This includes traditional bank gateways, virtual currency gateways, and promotional gateways. This provides the fulfillment and settlement of tenant subscription of the multi-tenant AI solution model compute processor between a buyer and a seller.

5. AI-TMTSN: AI Trusted Multi-Tenant Service Network

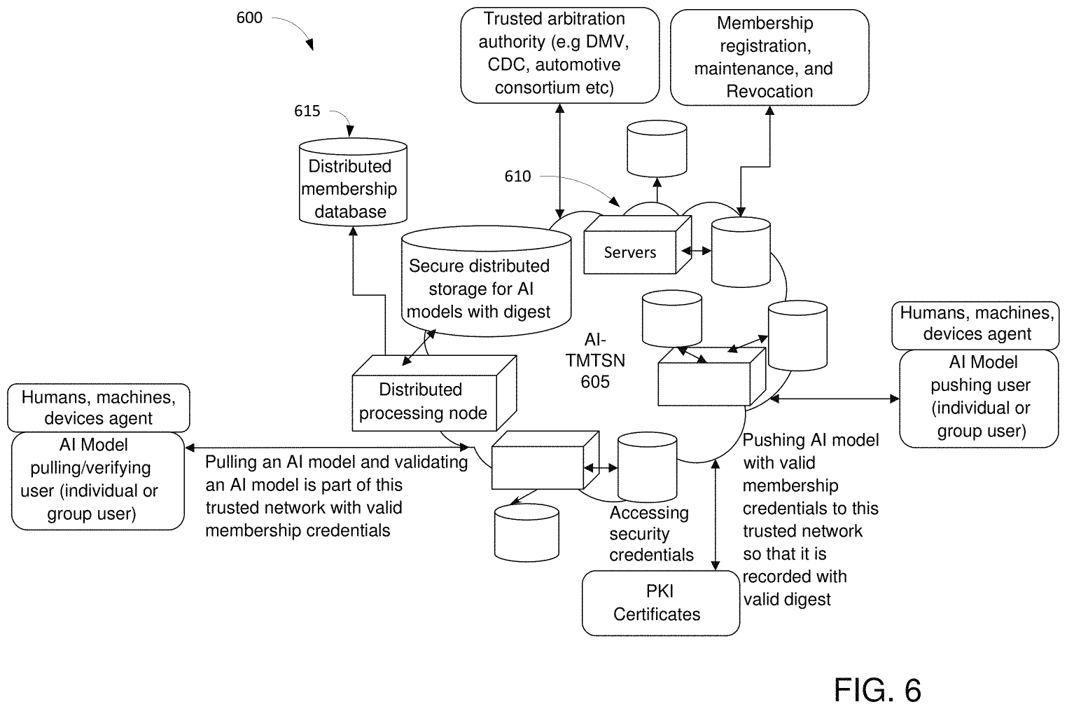

FIG. 6 shows a block diagram 600 of an overall AI trusted multi-tenant service network (AI-TMTSN) architecture 605, according to some embodiments. Various entities are involved, such as secure distributed processing nodes, a secure distributed database 615 configured to store encrypted data with digest entries, roles of each entity, and various stake holders. The AI-TMTSN also includes a flow from/to entity and a trusted model network, as well as a members registration (individual or group user) module. One or more servers 610 may be used to provide processing and storage for user registration, maintenance, and user revocation, and as well providing the physical infrastructure for carrying out other listed functions in the AI-TMTSN 605. Shown also are a members verification and authentication module, an entry by authorized member module, and a module for association with an authorized user. The overall system may be communicated across using encryption, as validation and verification may be part of the network protocols to ensure security.

In some embodiments, a distributed processing node of an AI-TMTSN implements various services, including: membership authentication & verification, multi-tenant AI solution model compute processor verification & validation, and multi-tenant AI solution model compute processor digest creation. In addition, each AI solution model compute processor may be given a unique signature for unique identification. Furthermore, the AI-TMTSN may provide encryption of info records, which may include as parameters, keys to one or more AI model data residing in the AI-TMTSN. These info records may be associated with a given multi-tenant AI solution model compute processor. The AI-TMTSN may also provide a mapping or association between an AI solution model compute processor and the provider who built or generated it, which may be tied to valid credentials of the provider.

In addition, the records associated with an AI solution model compute processor may be linked together to create an info record train/chain, for example using block chain technology. This may be used to prevent any of the info records from being tampered with or altered. There can be multiple groups of info record trains/chains, where each one may represent different providers, or other different ways of organizing the data. Each provider can be an individual user or an organization.

The AI-TMTSN may also provide dynamic secure key creation and management of a subscription key, according to some embodiments. This may include providing a time bound subscription key for a given tenant user subscriber. Subscription keys are created for an AI solution model compute processor with various coded types and execution rights and assigned to the subscriber user. The subscription key may be coded with various access rights:
I. Compute Processor Schedule Type:

i. Shared;

ii. Dedicated;
II. Compute Processor Function Type:

i. Inference & Decision;

ii. Training;

iii. Both;
III. AI Solution Model Need Type:

i. Bring your own model; and

ii. Subscribe to a specific model of the platform.

Compute code rights may be created by combining a selected type from each of the categories I, II, & III.

In some embodiments, the AI-TMTSN is also configured to:

a. Ascertain the identity of a member belonging to it through membership credentials;

b. Verify that the AI solution model compute processor belongs to the particular AI-TMTSN;

c. Allow storage and retrieval of AI solution model compute processor records to/from the AI-TMTSN in a distributed fashion;

d. Provide provision to monitor and detect bad members for accountability through a trusted arbitration authority; and

e. Perform various credential acquisitions from the AI-TMTSN, including using a time bound subscription key and enforce the credentials while running an AI solution model compute processor for a given user tenant subscriber member.

In some embodiments, the AI-MTSB, AI-MTSSM, AI-MTSMP make use of AI-TMTSN features and functionalities as and when deemed necessary.

6. AI-UDS: AI-User Device Server

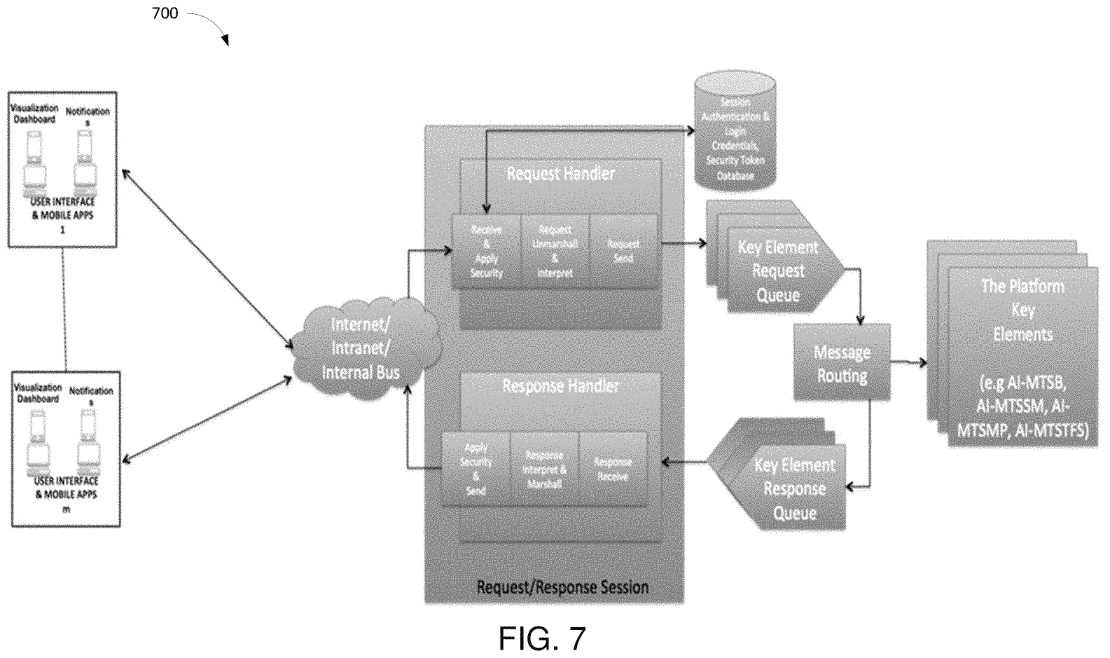

FIG. 7 shows an example diagram 700 of the AI user device server (AI-UDS) and its interactions to components of the service platform, according to some embodiments. The AI-UDS provides a primary secure interface to all subscriber tenants and their corresponding user devices. These may include mobile devices, laptops and other devices running user interface & visualization tools and apps.

The AI-UDS provides a key entry point to all the notable modules within the platform, such as the other modules described above. The AI-UDS may also handle all the requests and responses for interpretation, queuing and routing to/from these modules of the platform.

7. AI Multi Tenancy Service User Interface and Mobile Apps

Each of the modules of the platform may expose various user interfaces of the platform to the various user devices and their mobile apps to accomplish respective tasks.

Multi-Tenant Capable AI Solution Model Compute Processors

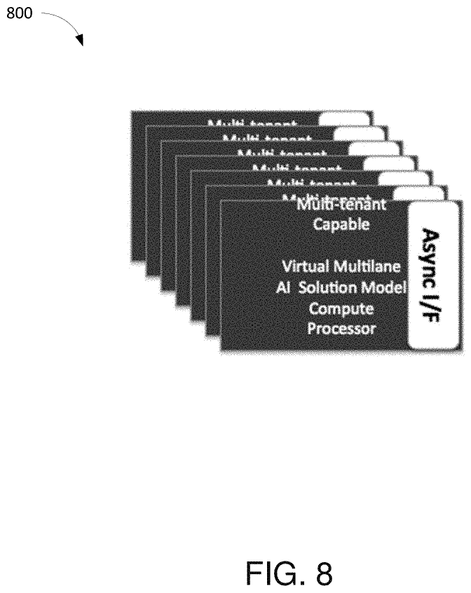

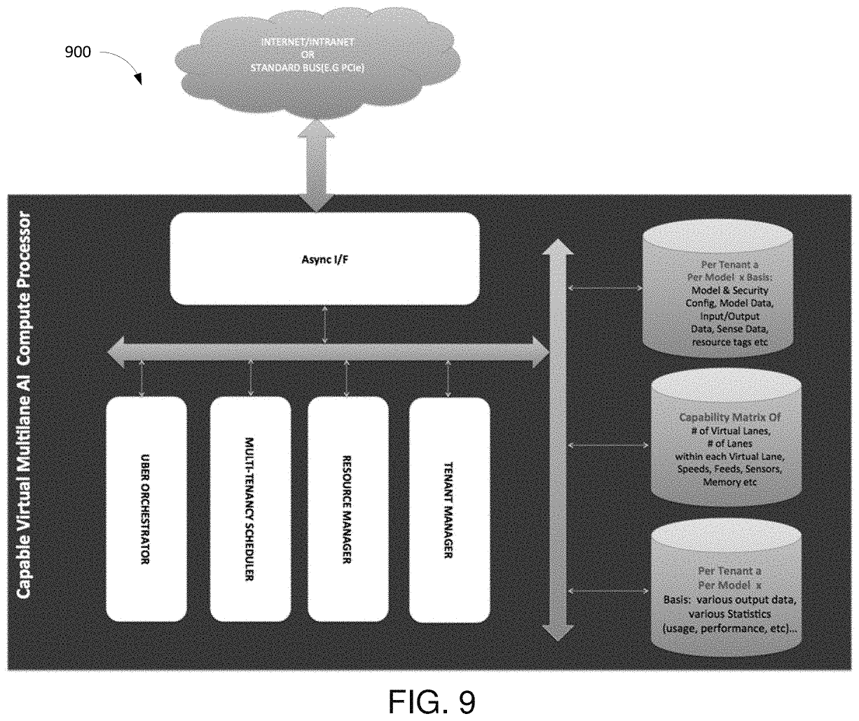

FIG. 8 shows a representation 800 of multiple AI solution model compute processors. Each AI solution model compute processor may be comprised of various hardware and software components, such as those described in U.S. Provisional Patent Application 62/801,046, and U.S. Provisional Patent Application 62/801,048, which are again incorporated herein by reference. Each AI solution model compute processor may be physically stationed remotely in different geographic locations, and connected via a wired or wireless network via Internet or intranet. The connections may be commonly coupled to the marketplace service, which again, determines what users will utilize the time and resources of each of the Ai solution model compute processors and during what times. The AI solution model compute processors may be capable of perform work for multiple users at the same time, in a multi-tenancy capacity. One or more of these AI solution model compute processors may enable this dynamic pay-as-you-use AI solution model processor service. FIG. 9 shows a system diagram 900 of this concept.

Referring to FIG. 9, there are some notable components of a management layer for a multi-tenant capable AI solution model compute processor that will be discussed in some detail herein. These include:
1. Async I/F (Asynchronous Interface);
2. Tenant Subscriber Manager;
3. Resource Manager;
4. Multi-tenancy Scheduler; and
5. Uber Orchestrator.

1. Async I/F (Asynchronous Interface)

The Async interface is embedded as part of each multi-tenant capable AI solution model processor and provides bi-directional, asynchronous communication to/from an AI-MTSB to use the multi-tenancy AI solution model processor environment in a trusted and secure manner. The Async interface may include circuitry and software for receiving and transmitting data, and memory for storing the data.

All the requests come through the AI-MTSB. The requests received from the AI-MTSB for allocation and execution may be tagged with a time-bound subscription key/token, along with appropriate security and trust credentials.

Since each subscriber key/token is embedded with appropriate execution coding, the Async I/F decodes and invokes appropriate handlers for fulfilling the requests/responses.

2. Tenant Subscriber Manager

This module keeps track of all records belonging to the tenant subscriber, including information about each tenant and what models they are subscribed to. This module may include a database stored in memory for storing information, and software for accessing the information and providing it upon request. Information associated with these concepts may include security config data, model config data, sensor context, and various execution tags. This information can be pulled out from the AI-MTSSN via a tenant ubscriber key.

3. Resource Manager

This module keeps track of all AI solution model compute resources, and their available capabilities. These capabilities may include the number of virtual lanes, number of lanes within each corresponding virtual lane, and capabilities of each lane including speeds, feeds, sensing/actuation, memory, etc. The resource manager may advertise these capabilities or make it discoverable to the AI-MTSB. This module may include a database stored in memory for storing information, and software for accessing the information and providing it upon request.

In coordination with the tenant subscriber manager and multi-tenancy scheduler, the resource manager may allocate required resources based on the time bound subscriber key coding information.

Finally, in coordination with other modules, the resource manager may receive, store and provide various usage, performance, error, security and other statistics to the AI-MTSB.

4. Multi-Tenancy Scheduler

In coordination with the resource manager, the multi-tenancy scheduler may schedule, allocate and provide scheduling for execution to the uber orchestrator. The multi-tenancy scheduler may also provide current allocation to a given tenant based on the time bound subscription key. The scheduler may be implemented in software using one or more processors and one more memories, for example.

Various types of multi-tenancy scheduling supported include:

A. Dedicated virtual multilane: Specific virtual lanes can be dedicated completely for a tenant (AI model) for a specific duration/lifetime. This may be based on the subscription key coding parameters.

B. Time multiplexed virtual multilane: Lanes can be shared between multiple tenants. This may be shared based on time, or based on resources that will be shared on a secured and proper isolation manner. The resources may be shared using AI system virtual lane technology described in U.S. Provisional Applications 62/801,046 and 62/801,048, for example, which again are incorporated herein by reference. Also, the I/Os and sensors, as well as memory (e.g., RAM) and storage (e.g., SSDs) may also be shared in a secure manner that is properly isolated.

In general, the multi-tenancy scheduler operates in tight coordination and cooperation with the uber orchestrator.

5. Uber Orchestrator

The uber orchestrator, upon receiving the execution calendar from the multi-tenancy scheduler, works with respective orchestrators on a per virtual lane basis to compose and send appropriate execution data and triggers for execution, and receives completion signals that it passes back to the scheduler. U.S. Provisional Applications 62/801,046, 62/801,048, and 62/801,050, which again are incorporated herein by reference, describe this process more, for example.

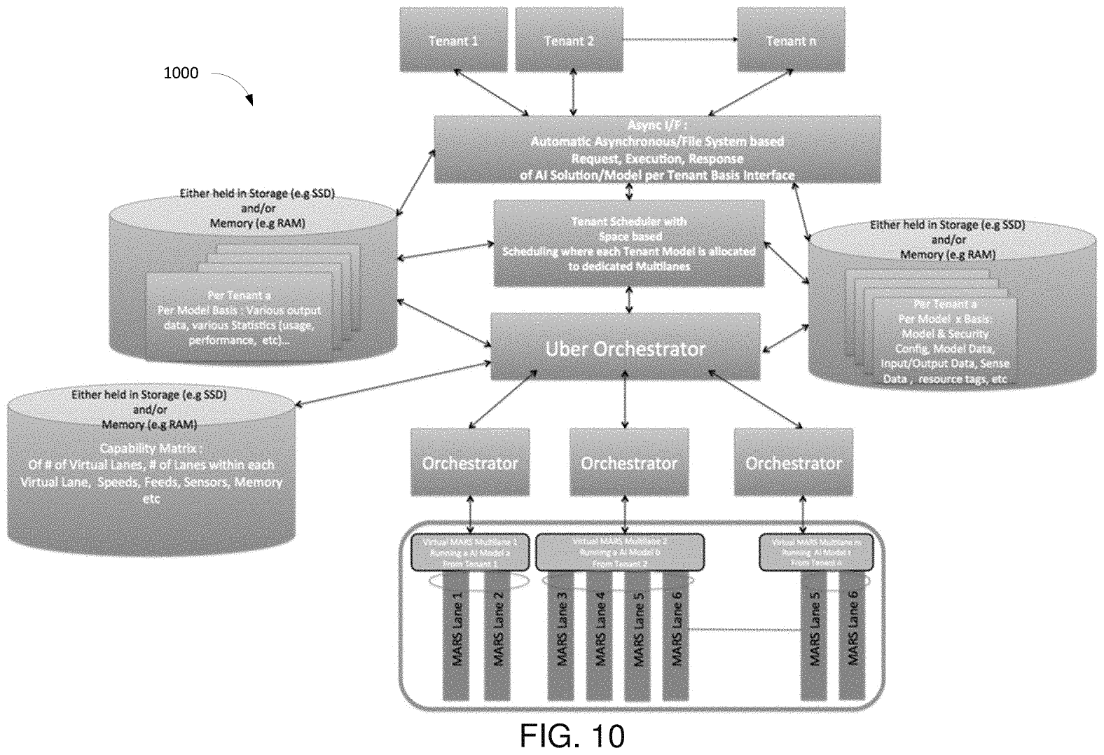

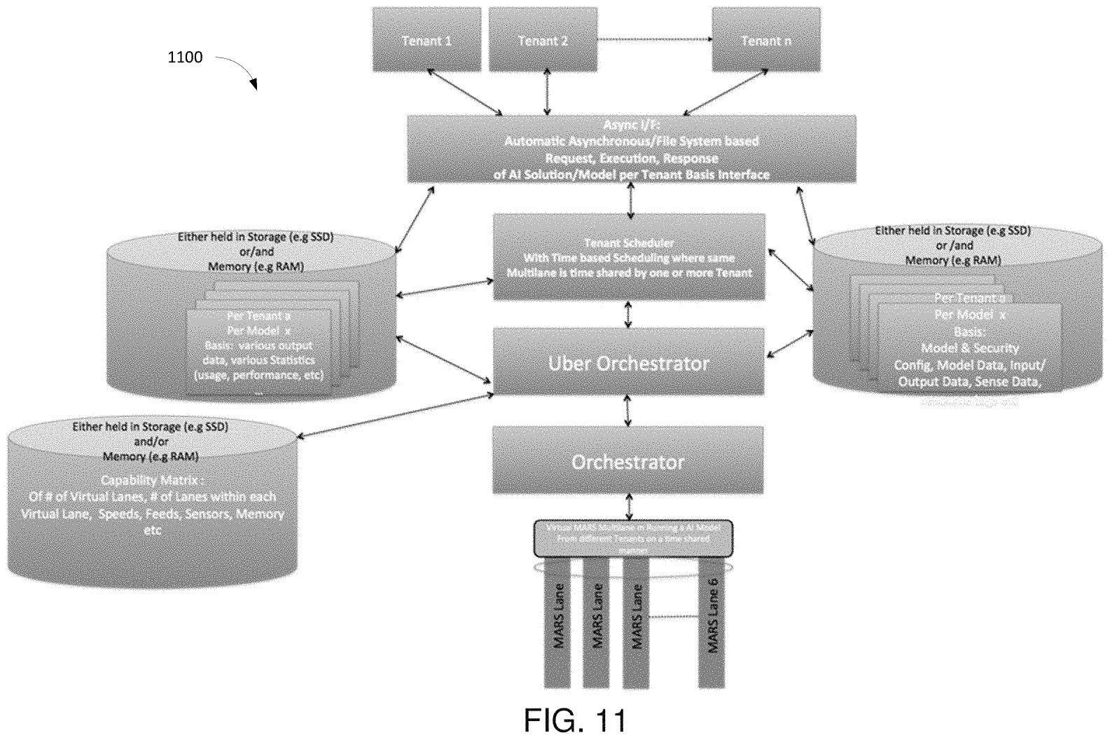

FIGS. 10 and 11 show the multi-tenancy scheduler 1000 and uber orchestrator 1100 coordinating to accomplish the required multi-tenancy execution. All the executions are taking place in a secure and trusted manner. FIG. 10 shows an example 1000 of the multi-tenancy execution in a dedicated virtual multilane configuration, while FIG. 11 shows an example 1100 of the multi-tenancy execution in a time multiplexed virtual multilane configuration.

While several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, those skilled in the art will appreciate that the mechanisms of the subject matter described herein are capable of being distributed as one or more program products in a variety of forms and that an illustrative form of the subject matter described herein applies regardless of the particular type of signal-bearing medium used to actually carry out the distribution.

Instructions used to program logic to perform various disclosed aspects can be stored within a memory in the system, such as DRAM, cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, CD-ROMs, magneto-optical disks, ROM, RAM, EPROM, EEPROM, magnetic or optical cards, flash memory, or tangible, machine-readable storage used in the transmission of information over the Internet via electrical, optical, acoustical, or other forms of propagated signals (e.g., carrier waves, infrared signals, digital signals). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, DSP, PLD, programmable logic array (PLA), or FPGA), state machine circuitry, firmware that stores instructions executed by programmable circuitry, and any combination thereof. The control circuit may, collectively or individually, be embodied as circuitry that forms part of a larger system, for example, an integrated circuit, an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application-specific integrated circuit, electrical circuitry forming a general-purpose computing device configured by a computer program (e.g., a general-purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer-readable storage medium. Firmware may be embodied as code, instructions, instruction sets, and/or data that are hard-coded (e.g., non-volatile) in memory devices.

As used in any aspect herein, the terms “component,” “system,” “module,” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet-switched network. The communication devices may be capable of communicating with each other using a selected packet-switched network communications protocol. One example communications protocol may include an Ethernet communications protocol which may be capable permitting communication using a Transmission Control Protocol/IP. The Ethernet protocol may comply or be compatible with the Ethernet standard published by the Institute of Electrical and Electronics Engineers (IEEE) titled “IEEE 802.3 Standard,” published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum, titled “ATM-MPLS network Interworking 2.0,” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, and/or standby-state components, unless context requires otherwise.

The terms “proximal” and “distal” are used herein with reference to a clinician manipulating the handle portion of the surgical instrument. The term “proximal” refers to the portion closest to the clinician, and the term “distal” refers to the portion located away from the clinician. It will be further appreciated that, for convenience and clarity, spatial terms such as “vertical,” “horizontal,” “up,” and “down” may be used herein with respect to the drawings. However, surgical instruments are used in many orientations and positions, and these terms are not intended to be limiting and/or absolute.

Those skilled in the art will recognize that, in general, terms used herein, and especially in the appended claims (e.g., bodies of the appended claims), are generally intended as “open” terms (e.g., the term “including” should be interpreted as “including, but not limited to”; the term “having” should be interpreted as “having at least”; the term “includes” should be interpreted as “includes, but is not limited to”). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations or two or more recitations). Furthermore, in those instances where a convention analogous to “at least one of A, B, and C, etc.” is used, in general, such a construction is intended in the sense that one having skill in the art would understand the convention (e.g., “a system having at least one of A, B, and C” would include, but not be limited to, systems that have A alone, B alone, C alone, A and B together, A and C together, B and C together, and/or A, B, and C together). In those instances where a convention analogous to “at least one of A, B, or C, etc.” is used, in general, such a construction is intended in the sense that one having skill in the art would understand the convention (e.g., “a system having at least one of A, B, or C” would include, but not be limited to, systems that have A alone, B alone, C alone, A and B together, A and C together, B and C together, and/or A, B, and C together). It will be further understood by those within the art that typically a disjunctive word and/or phrase presenting two or more alternative terms, whether in the description, claims, or drawings, should be understood to contemplate the possibilities of including one of the terms, either of the terms, or both terms, unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures, or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials are not inconsistent herewith. As such, and to the extent necessary, the disclosure as explicitly set forth herein supersedes any conflicting material incorporated herein by reference. Any material, or portion thereof, that is said to be incorporated by reference herein but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

### EXAMPLES

Various aspects of the subject matter described herein are set out in the following numbered examples:

### Example 1

A service delivery platform system for facilitating renting of artificial intelligence (AI) model processing, the system comprising: an AI multi-tenancy service broker (AI-MTSB), configured to: interface with one or more multi-tenant capable AI model compute processors configured to perform training and inference of AI models; allocate appropriate resources from the one or more AI model compute processors to perform training or inference on behalf of a renting tenant; and facilitate execution of the AI models, using the allocated resources from the one or more AI model compute processors, on behalf of the renting tenant; an AI multi-tenancy service subscriber manager (AI-MTSSM) configured to manage a subscription of the renting tenant for access to utilize the resources of the one or more AI model compute processors, wherein the subscription defines a time duration, frequency, and amount of resources of the one or more AI model compute processors accessible to the renting tenant; and an AI-trusted multi-tenant service network (AI-TMTSN) configured to manage membership of a provider that controls operation of the one or more AI model compute processors.

### Example 2

The system of Example 1, further comprising an AI multi-tenancy service marketplace (AI-MTSMP) configured to facilitate real time bidding of subscriptions to the one or more AI model compute processors.

### Example 3

The system of Example 1 or 2, further comprising an AI multi-tenancy transaction fulfillment system (AI-MTSTFS) configured to facilitate payment transactions of the subscription for utilizing the one or more AI model compute processors by the renting tenant.

### Example 4

The system of any of Examples 1 to 3, further comprising an AI user device server (AI-UDS) configured to provide an interface from the system to a remote device of the renting tenant.

### Example 5

The system of any of Examples 1 to 4, further comprising an AI multi-tenancy service user interface, directly from at least one of the AI-MTSB, the AI-MTSSM, and the AI-MTMSN, to one or more remote devices of the renting tenant.

### Example 6

The system of any of Examples 1 to 5, wherein the provider that controls the one or more AI model compute processors is a different entity than one that controls the service delivery platform system.

### Example 7

The system of any of Examples 1 to 6, wherein the AI-MTSSM further comprises a ratings system to allow users to rate quality and/or performance of subscriptions to utilize AI model compute processors.

### Example 8

A multi-tenant capable artificial intelligence (AI) solution model compute processor, comprising: an asynchronous interface configured to: provide bi-directional, asynchronous communication between a remote service broker and the AI solution model compute processor; and receive instructions for performing AI solution model training or inference from the remote service broker; a tenant subscriber manager configured to record information associated with a renting tenant, the information defining a time duration, frequency, and amount of resources of the AI solution model compute processor that is accessible to the renting tenant; and a resource manager configured to manage the processor resources of the AI solution model; wherein the AI solution model compute processor is configured to conduct training or inference of an AI solution model on behalf of a renting tenant through instructions by a service delivery platform system for facilitating renting of AI model processing, the service delivery platform comprising the remote service broker.

### Example 9

The AI solution model compute processor of Example 8, further comprising a multi-tenancy scheduler configured to schedule resources of the AI solution model compute processor to be able to execute a training or inference of the AI solution model in accordance with a subscription of the renting tenant that specifies a time duration, frequency, and amount of resources for utilizing the AI solution model.

### Example 10

The AI solution model compute processor of Example 9, further comprising an uber orchestrator configured to activate one or more virtual lanes of the AI solution model compute processor to perform a training or inference of an AI solution model, based on instructions from the multi-tenancy scheduler.

### Example 11

The AI solution model compute processor of any of Examples 8 to 10, wherein the resource manager configured to manage the processor resources comprises keeping track of available virtual lanes, number of lanes within each virtual lane, and capabilities of each lane including speed, sensing capacity, and memory.

### Example 12

The AI solution model compute processor of any of Examples 8 to 11, wherein the remote service broker is configured to:
interface with the AI solution model compute processor;
allocate appropriate resources from the AI solution model compute processor to perform training or inference on behalf of the renting tenant; and
facilitate execution of the AI solution model using the allocated resources from the AI solution model compute processor, on behalf of the renting tenant.

### Example 13

The AI solution model compute processor of any of Examples 8 to 12, wherein the resource manager is further configured to cease providing the processor resources for execution of the AI solution model to the renting tenant after the time duration, frequency, or amount of resources of the AI solution model compute processor that is accessible to the renting tenant has been reached, according to the information of the tenant subscriber manager.

### Example 14

The AI solution model compute processor of any of Examples 8 to 13, wherein the renting tenant is a first renting tenant, and wherein the AI solution model compute processor is further configured to conduct training or inference of the same AI solution model as the first renting tenant on behalf of a second renting tenant simultaneously with the first renting tenant.

### Example 15

An artificial intelligence (AI) multi-tenancy service broker (AI-MTSB), comprising one or more circuits coupled to a memory, and configured to:
interface with one or more multi-tenant capable AI model compute processors configured to perform training and inference of AI models;
allocate appropriate resources from the one or more AI model compute processors to perform training or inference on behalf of a renting tenant; and
facilitate execution of the AI models, using the allocated resources from the one or more AI model compute processors, on behalf of the renting tenant.

### Example 16

The AI multi-tenancy service broker of Example 15, further configured to interface with an AI multi-tenancy service subscriber manager (AI-MTSSM) configured to manage a subscription of the renting tenant for access to utilize the resources of the one or more AI model compute processors, wherein the subscription defines a time duration, frequency, and amount of resources of the one or more AI model compute processors accessible to the renting tenant.

### Example 17

The AI multi-tenancy service broker of Example 15 or 16, further configured to interface with an AI-trusted multi-tenant service network (AI-TMTSN) configured to manage membership of a provider that controls operation of the one or more AI model compute processors.

### Example 18

The AI multi-tenancy service broker of any of Examples 15 to 17, further configured to interface with an AI multi-tenancy service marketplace (AI-MTSMP) configured to facilitate real time bidding of subscriptions to the one or more AI model compute processors.

### Example 19

The AI multi-tenancy service broker of any of Examples 15 to 18, further configured to interface with an AI multi-tenancy transaction fulfillment system (AI-MTSTFS) configured to facilitate payment transactions of the subscription for utilizing the one or more AI model compute processors by the renting tenant.

### Example 20

The AI multi-tenancy service broker of any of Examples 15 to 19, further configured to interface with an AI user device server (AI-UDS) configured to provide an interface from the system to a remote device of the renting tenant.

What is claimed is:

1. A service delivery platform system for facilitating renting of artificial intelligence (AI) model processing, the system comprising:
an AI multi-tenancy service broker (AI-MTSB), configured to:
interface with one or more multi-tenant capable AI model compute processors configured to perform training and inference of AI models;
allocate appropriate resources from the one or more AI model compute processors to perform training or inference on behalf of a renting tenant; and
facilitate execution of the AI models, using the allocated resources from the one or more AI model compute processors, on behalf of the renting tenant;
an AI multi-tenancy service subscriber manager (AI-MTSSM) configured to manage a subscription of the renting tenant for access to utilize the resources of the one or more AI model compute processors, wherein the subscription defines a time duration, frequency, and amount of resources of the one or more AI model compute processors accessible to the renting tenant; and
an AI-trusted multi-tenant service network (AI-TMTSN) configured to manage membership of a provider that controls operation of the one or more AI model compute processors.

2. The system of claim 1, further comprising an AI multi-tenancy service marketplace (AI-MTSMP) configured to facilitate real time bidding of subscriptions to the one or more AI model compute processors in a secure manner such that data associated with a user participating in the AI-MTSMP is not accessible to another user without permission.

3. The system of claim 1, further comprising an AI multi-tenancy transaction fulfillment system (AI-MTSTFS) configured to facilitate payment transactions of the subscription for utilizing the one or more AI model compute processors by the renting tenant.

4. The system of claim 1, further comprising an AI user device server (AI-UDS) configured to provide an interface from the system to a remote device of the renting tenant in a secure manner such that data associated with the renting tenant utilizing the AI-UDS is not accessible to another user without permission.

5. The system of claim 1, further comprising an AI multi-tenancy service user interface, directly from at least one of the AI-MTSB, the AI-MTSSM, and the AI-MTMSN, to one or more remote devices of the renting tenant.

6. The system of claim 1, wherein the provider that controls the one or more AI model compute processors is a different entity than one that controls the service delivery platform system.

7. The system of claim 1, wherein the AI-MTSSM further comprises a ratings system to allow users to rate quality and/or performance of subscriptions to utilize AI model compute processors.

8. A multi-tenant capable artificial intelligence (AI) solution model compute processor, comprising:
an asynchronous interface configured to:
provide bi-directional, asynchronous communication between a remote service broker and the AI solution model compute processor; and
receive instructions for performing AI solution model training or inference from the remote service broker;
a tenant subscriber manager configured to record information associated with a renting tenant, the information defining a time duration, frequency, and amount of resources of the AI solution model compute processor that is accessible to the renting tenant; and
a resource manager configured to manage the processor resources of the AI solution model;
wherein the AI solution model compute processor is configured to conduct training or inference of an AI solution model on behalf of the renting tenant through instructions by a service delivery platform system for facilitating renting of AI model processing, the service delivery platform comprising the remote service broker.

9. The AI solution model compute processor of claim 8, further comprising a multi-tenancy scheduler configured to schedule resources of the AI solution model compute processor to be able to execute a training or inference of the AI solution model in accordance with a subscription of the renting tenant that specifies a time duration, frequency, and amount of resources for utilizing the AI solution model.

10. The AI solution model compute processor of claim 9, further comprising an uber orchestrator configured to activate one or more virtual lanes of the AI solution model compute processor to perform a training or inference of an AI solution model, based on instructions from the multi-tenancy scheduler.

11. The AI solution model compute processor of claim 8, wherein the resource manager configured to manage the processor resources comprises keeping track of available virtual lanes, number of lanes within each virtual lane, and capabilities of each lane including speed, sensing capacity, and memory.

12. The AI solution model compute processor of claim 8, wherein the remote service broker is configured to:
interface with the AI solution model compute processor;
allocate appropriate resources from the AI solution model compute processor to perform training or inference on behalf of the renting tenant; and
facilitate execution of the AI solution model using the allocated resources from the AI solution model compute processor, on behalf of the renting tenant.

13. The AI solution model compute processor of claim 8, wherein the resource manager is further configured to cease providing the processor resources for execution of the AI solution model to the renting tenant after the time duration, frequency, or amount of resources of the AI solution model compute processor that is accessible to the renting tenant has been reached, according to the information of the tenant subscriber manager.

14. The AI solution model compute processor of claim 8, wherein the renting tenant is a first renting tenant, and wherein the AI solution model compute processor is further configured to conduct training or inference of the same AI solution model as the first renting tenant on behalf of a second renting tenant simultaneously with the first renting tenant.

15. An artificial intelligence (AI) multi-tenancy service broker (AI-MTSB), comprising one or more circuits coupled to a memory, and configured to:
interface with one or more multi-tenant capable AI model compute processors configured to perform training and inference of AI models;
allocate appropriate resources from the one or more AI model compute processors to perform training or inference on behalf of a renting tenant; and
facilitate execution of the AI models, using the allocated resources from the one or more AI model compute processors, on behalf of the renting tenant.

16. The AI multi-tenancy service broker of claim 15, further configured to interface with an AI multi-tenancy service subscriber manager (AI-MTSSM) configured to manage a subscription of the renting tenant for access to utilize the resources of the one or more AI model compute processors, wherein the subscription defines a time duration, frequency, and amount of resources of the one or more AI model compute processors accessible to the renting tenant.

17. The AI multi-tenancy service broker of claim 15, further configured to interface with an AI-trusted multi-tenant service network (AI-TMTSN) configured to manage membership of a provider that controls operation of the one or more AI model compute processors.

18. The AI multi-tenancy service broker of claim 15, further configured to interface with an AI multi-tenancy service marketplace (AI-MTSMP) configured to facilitate real time bidding of subscriptions to the one or more AI model compute processors.

19. The AI multi-tenancy service broker of claim 15, further configured to interface with an AI multi-tenancy transaction fulfillment system (AI-MTSTFS) configured to facilitate payment transactions of the subscription for utilizing the one or more AI model compute processors by the renting tenant.

20. The AI multi-tenancy service broker of claim 15, further configured to interface with an AI user device server (AI-UDS) configured to provide an interface from the system to a remote device of the renting tenant.
